(19) United States
(12) Patent Application Publication
(10) Pub. No.: US 2017/0255970 A1
(43) Pub. Date: Sep. 7, 2017

(54) Compensation based removable Mobile Advertising

(71) Applicants: Gregory W. Kunsch, Virginia Beach, VA (US); Alexander Andre Kunsch, Virginia Beach, VA (US)

(72) Inventors: Gregory W. Kunsch, Virginia Beach, VA (US); Alexander Andre Kunsch, Virginia Beach, VA (US)

(21) Appl. No.: 15/062,084

(22) Filed: Mar. 5, 2016

(51) Int. Cl. G06Q 30/02

(52) U.S. Cl. CPC G06Q 30/0273; G06Q 30/0272; G09F 21/048

(57) ABSTRACT

A mobile advertising system which has signage displayed on a vehicle. The signage can be deployed, removed, and redeployed at will by the vehicle owner. The signage is linked wirelessly to a central unit on the vehicle which validates the signage is deployed, and tracks the time or distance the vehicle travels with the signage deployed. An invoicing and tracking system may be included that computes an advertising charge based on the time or distance the vehicle travels during which the signage is deployed and, optionally, the location of the vehicle. A system may also be included which allows connection between vehicle owners willing to utilize vehicles for advertising, and the associated advertisers interested in advertising, for the purpose of establishing a billing rate or a contract for displaying signage.

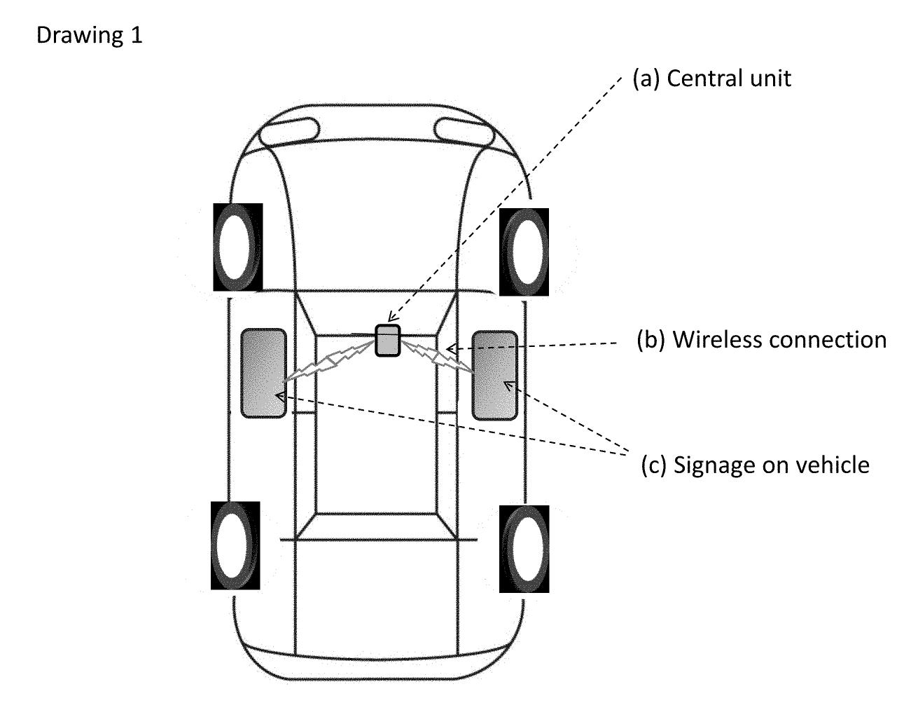

### BACKGROUND

Field of the Invention:

The present invention pertains to mobile visual advertising.

Description of the Related Art

The advertising field of art has several methods to advertise and promote products or services in an outdoor environment through the use of vehicles. Common examples include advertising which is painted on vehicles, large adhesive decals applied to vehicles, signs affixed to vehicles, and vehicles with purpose built mobile banners. Each method has limitations in application, for example:
Signs affixed to vehicles lack verification of deployment and display. Vehicle owners may claim that the sign has been displayed, when it has not. Advertisers have no method of validating signage was actually displayed, nor the time or distance or location in which it was displayed.
Vehicle owners are reluctant to have their vehicle painted or have fixed decals attached to their vehicle because the signage is not easily removable and is displayed at all times. Thus, this form of advertising is limited, typically only extending to company owned vehicles, trucks, buses, or small business owners which display on their vehicles.
Purpose built banner vehicles which display signage are costly and limited in coverage. The approach does not allow daily commuter vehicles to be utilized for advertising efforts.

There are no revenue generating methods for simple vehicle based advertising which can be effectively extended to common vehicles in a manner which is both attractive to the vehicle owner, and can assure the advertiser that billing is associated with actual signage deployment. The intent of the present invention is to provide a simple mechanism to common commuter vehicle owners so that they can easily deploy and remove advertising signage at will, redeploy at will, and be compensated for duration the signage is deployed. At the same time, the present invention is intended to provide the advertiser an assurance level that compensation is only incurred when the signage is deployed.

Other proposed systems have more complex approaches, including real time data display updates, changing spot location advertising, onboard or portable wireless communication systems or devices for improved up-dating of the ad message and spot location advertising, camera integration such as onboard or portable video or still cameras, streaming media, and peer to peer communications. Systems have been proposed to update, on a real-time, streaming or down loadable basis, the advertising media or other information in order to, for instance, change ad copy/messages. All these aforementioned systems and methods are more complex and costly, often lacking a verification method of signage deployment, and lacking the simple efficiency of fixed message advertising signs.

### SUMMARY OF THE INVENTION

The present invention allows virtually any vehicle to become an advertising mechanism, providing the advertiser a means to rapidly engage large audiences, while providing revenue opportunities for the vehicle owners. The present invention utilizes signage temporarily affixed to and displayed on the vehicle. The signage is linked wirelessly to a central unit which validates the signage is deployed, and tracks the time or distance the vehicle travels with the signage deployed. An invoicing and tracking system may be included that computes an advertising charge based on the time or distance the vehicle the vehicle travels during which the signage is deployed and, optionally, the location of the vehicle. Signage may be affixed or removed by the vehicle owner at any time, allowing the vehicle owner the flexibility to determine when and where they elect to advertise. Advertisers have numerous options to compensate vehicle owners based on time, date, distance, and even location of when the advertising was displayed. There are additional options in establishing compensation where the vehicle owner could offer rates to the advertisers, or conversely, advertisers could provide pre-set rates, or even allow bidding to develop market based rates. Advertisers could also select based on vehicle type, owner location, or other factors.

### DESCRIPTION OF THE SEVERAL VIEWS OF THE DRAWING

Drawing (1): Shows an embodiment of the present invention with a flattened, non-proportional plan view of vehicle with the following basic system components:
Item (a)—Central Unit
Item (b)—Wireless connection to the signage
Item (c)—Signage

Before any embodiments of the invention are explained in detail, it is to be understood that the invention is not limited in its application to the details of construction and the detailed arrangement of components set forth in the following description or illustrated in the following drawings. The invention is capable of other embodiments not listed herein, and of being practiced or of being carried out in various ways. Also, it is to be understood that the phraseology and terminology used herein is for the purpose of description and should not be regarded as limiting.

### DETAILED DESCRIPTION OF THE INVENTION

Drawing (1) depicts the basic components of the core system. The system has signage (item c). The advertisement is printed or depicted on this signage. There is a central unit (item a) which tracks vehicle movement, time, and other information. Information collected is used for billing and invoicing purposes. The central unit is linked wirelessly (item b) to the signage to verify signage is deployed.

The signage (item c) can be made of plastic, magnet, metal, or any other material. The signage advertising can be via printing, laminating, painting, embossing, or any other medium. The signage is affixed to the vehicle in a non-permanent method; embodiments can include straps, adhesive, magnetic, or other mounting methods. The signage can be deployed or affixed by the vehicle owner, removed by the vehicle owner, and re-deployed or re-affixed by the vehicle owner. An exemplary embodiment would be a magnetic based sign for easy adhesion and removal, with a printed surface containing the advertisement. Signage could be deployed in various locations on the vehicle depending on how deployment verifications function. For example, signage could be located on the rear of the vehicle if deployment verification functions allowed for that location.

The central unit (item a) tracks vehicle information required for billing, which could include motion time, location, and distance. There are several embodiments to accomplish this; examples include interaction with the vehicle speedometer functions, vehicle odometer functions, accelerometers, cellular link locations, and GPS functions. An exemplary embodiment would be a GPS unit which tracks time, location, distance, and speed. GPS is not necessarily a required component, as another example embodiment could have linkage to the vehicle's odometer and a clock function. This embodiment also captures the elements of time and distance. This embodiment could also be augmented by cell tower linkages to determine the approximate vehicle location if the billing system was established to require it. Another embodiment of the central unit is a smartphone. The smartphone could be used as the central unit, using the wireless, and GPS or cellular triangulation capabilities of the phone. This embodiment allows typical consumer products to be used as component of the system. This further simplifies the system and reduces the cost of the system. This document refers the central unit a one logical component. Physically, the central unit does not necessarily need to be one unit or component, and may be deployed as multiple, separate physical portions of the system.

The central unit (item a) verifies signage deployment through a wireless connection (item c). There are numerous embodiments of the wireless and verification functions. Embodiments of the wireless include RFID, Active and passive tags, powered tags, power assisted tags, directional antennas, blue tooth and various RF frequencies and technologies. Embodiments of verification functions can include but are not limited to rfid connection, distance measuring, tag id verification, pressure switches for correct installation, magnetic sensors, temperature sensors, light sensors, spacial sensors, proximity sensors, and vertical position sensors in the sign linked to the central unit wirelessly. The verification mechanisms could either be imbedded directly in the sign, or linked to the sign.

An exemplary embodiment of verification of signage deployment would have wireless connections based on directional antennas from the central unit, each pointing outwards to the signage, verifying signs were opposite each other and the central unit was between them. Wireless distance could be either limited to, or distance calculated and verified to be less than a portion of the car width, ensuring signs were at proper distance. The serialized identification number of each sign would be verified to be valid, ensuring proper signs were installed. Sensors in the sign would determine if the sign was in vertical position, and disconnect wireless connection if sign was not vertical. Pressure or magnetic sensors or switches, or even photoelectric sensors would verify sign was deployed externally with advertising facing outwards. Even temperature sensors could be incorporated, to read temperatures and compare with local weather reports. These measures, fully or partially implemented, whether augmented with additional controls or not, would effectively verify signage deployment.

Additional optional components of the system could include a billing and invoicing mechanism, as well as a component to allow connection between vehicle owners willing to utilize vehicles for advertising and advertisers. There are numerous embodiments which could include vehicle owner posting, and advertiser acceptance, or visa-versa, with advertisers posting, and vehicle owners accepting. The method could use fixed rate, adjustable rates, or even a bidding process through which the market would determine the rate. An exemplary embodiment of this would include: A vehicle owner posts their vehicle information, a picture, and vehicle location. Advertiser would respond with proposed ad, and associated rate. Vehicle owner could accept rate, and after displaying signage according to the advertiser's agreement, billing would be calculated and applied through the invoicing system. The signage deployment and verification system would provide measurement of time, duration, or other contract components, and information would be passed to the invoicing system for billing, and subsequent compensation to the vehicle owner. This is a simple embodiment which is intended to provide understanding of the core system within the vehicle, and its possible interaction with extended portions of the system.

While this invention has been described with several embodiments, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A mobile advertising system comprising: removable and redeployable advertising signage on a vehicle; wireless connectivity from the signage to a unit to verify signage deployment; and time in motion or distance tracking of the vehicle during which the signage is deployed.

2. The mobile advertising system of claim 1 comprising an invoicing system that computes an advertising charge based at least in part on an amount of time in motion or distance the vehicle travels while the signage is deployed.

3. The mobile advertising system of claim 1 comprising a system allowing connection between vehicle owners willing to utilize vehicles for advertising and advertisers for the purpose of establishing a billing rate and contact for displaying signage.

4. A method of advertising comprising of removable and redeployable advertising signage on a vehicle; wireless connectivity from the signage to a unit to verify signage deployment; and time in motion or distance tracking of the vehicle during which the signage is deployed.

5. The method of claim 4, comprising an invoicing method that computes an advertising charge based at least in part on an amount of time in motion or distance the vehicle travels while the signage is deployed.

6. The mobile advertising method of claim 4 comprising a method of allowing connection between vehicle owners willing to utilize vehicles for advertising and advertisers for the purpose of establishing a billing rate and contact for displaying signage.
